(19) United States
(12) Patent Application Publication
(10) Pub. No.: US 2006/0153434 A1
(43) Pub. Date: Jul. 13, 2006

(54) Thick-slice display of medical images

(76) Inventor: Shih-Ping Wang, Los Altos, CA (US)

Correspondence Address: Cooper & Dunham, 1185 Avenue of the Ameicas, New York, NY, 10036, US

(21) Appl. No.: 10/536,623

(22) PCT Filed: Nov. 26, 2003
(86) PCT No.: PCT/US03/38164

§ 371 Date: Jan. 19, 2006

Related U.S. Application Data
(60) Provisional application No. 60/429,913, filed on Nov. 29, 2002.

(51) Int. Cl. G06K 9/00

(52) U.S. Cl. 382/128; 382/131; 382/132; 382/154

(57) ABSTRACT

A method and associated systems for processing and displaying three-dimensional medical imaging data of a subject anatomical volume is described in which a plurality of thick-slice images is computed and displayed each thick-slice image corresponding to a thick-slice or slab-like subvolume of the anatomical volume substantially parallel to a standard x-ray view plane for that anatomical volume. The thick-slice or slab-like subvolumes have a thickness generally related to a lesion size to be detected and/or examined. The described thick-slice processing and display is generally applicable for any anatomical volume (e.g.,chest, head, abdomen, breast, etc.) having associated standard x-ray views (e.g., PA, lateral. CC, MLO, etc.) that is also amenable to one or more three-dimensional imaging modalities (e.g., MRI, CT, SPECT, PET, ultrasound, etc.). According to one preferred embodiment in which the particular three-dimensional imaging modality is CT imaging, thick-slice processing and display is used to facilitate reduced screening radiation dosage.

### CROSS-REFERENCE TO RELATED APPLICATIONS

This application claims the benefit of U.S. Provisional Application No. 60/429,913 filed Nov. 29, 2002, which is incorporated by reference herein.

### FIELD

The present specification relates to medical imaging systems. More particularly, the present specification relates to a method for presenting three-dimensional volumetric imaging data to a medical professional in a manner that promotes screening and/or diagnostic efficiency and for three-dimensional imaging modalities involving x-ray radiation reduces radiation exposure risks.

### BACKGROUND

Magnetic resonance imaging (MRI) and computerized tomography (CT) imaging modalities are well-known to the medical community and have become established tools for imaging the head and the abdomen for diagnostic purposes. However, the MRI and CT imaging modalities have not been widely adopted for regular screening purposes. i.e., for regularly seeking out abnormalities that may be developing inside a patient prior to the development of symptoms.

One example of a regular screening process currently in use in the United States today is x-ray mammography, with regular yearly x-ray mammograms being recommended for women over 40. Radiologists have developed years of experience and expertise in analyzing two-dimensional x-ray mammograms for the early detection of breast cancer. Unfortunately, a substantial percentage of breast cancers still go undetected in today's two-dimensional x-ray mammography screening environment, the undetected cancerous lesions continuing to develop until symptoms are felt by which time it is sometimes too late to stop the spread of the disease.

It is believed that breast cancer screening results could be substantially improved by using a three-dimensional imaging modality, such as MRI or CT, in distinction to conventional two-dimensional x-ray mammography. It is further believed that a number of other abnormalities, such as lung cancers, brain tumors abnormal heart/artery structures/blockages, thyroid growths, etc. could be detected early enough for effective treatment if a screening program using such three-dimensional imaging modalities were effectively implemented. For simplicity and clarity of explanation herein the term lesion shall be used to generically denote a physical mass or growth associated with any of the above diseases or other conditions, it being appreciated that each particular disease or condition will have different terminology identifying its related masses, growths, and/or abnormal structures.

Cost is one of the primary obstacles to implementing such a thorough three-dimensional screening process using MRI or CT, although it is believed that the costs of CT scanning will ultimately decline to a point where cost is not a substantial barrier. Without loss of generality, the discussion and examples herein will deal with CT technology, it being understood that the preferred embodiments described herein are applicable to any three-dimensional imaging modality such as MRI, PET, SPECT, ultrasound, and other three-dimensional modalities.

An obstacle to implementing a thorough three-dimensional screening process, which is related to cost but which also affects the sensitivity and specificity of the screening process is the extensive time needed for the radiologist or other medical professional to analyze the volumes of data provided by the CT system (or other three-dimensional imaging system). Today's CT systems which can achieve up to 1 mm or better resolution, can provide in the range of 100-1000 planar images or slices for a single chest CT, and in the range of 50-500 slices for a breast CT or a head CT. For chest and head CTs these slices are axial slices, i.e., perpendicular to a head-to-toe axis of the patient. Whereas a radiologist would have previously reviewed only a single 17″×14″ posterior-anterior (PA) chest x-ray and associated lateral view, the radiologist would instead be presented with 100-1000 axial slices. For breast CTs, these slices would be parallel to the chest wall or coronal plane of the patient. This would represent an enormous amount of information to be reviewed by a radiologist, even if computer-aided diagnosis (CAD) markers were present on some of the slices to assist in locating suspicious lesions.

Moreover, most of the physicians and radiologists screening the data would likely not be familiar with the axial views of the chest and abdomen, or with breast slices parallel to the chest wall. This is because the physicians and radiologists will likely have been trained using standard x-ray views of the different portions of the anatomy. For the chest and abdomen, the standard x-ray views include the posterior-anterior (PA) x-ray view and the lateral x-ray view. For the head and neck the standard x-ray views include the anterior-posterior (AP) x-ray view and the lateral x-ray view. For the breast, the standard x-ray views include the mediolateral obliquc (MLO) and craniocaudal (CC) views. The physicians have developed an extensive knowledge base and experience base with these standard x-ray views that allows them to differentiate suspicious lesions from surrounding normal tissues even when the visual cues are very subtle and when the image would otherwise look “normal” to the untrained or less-trained eye. The extension of this experience and expertise would likely not carry over well to axial viewing planes.

Another obstacle to the use of CT in a regular screening program is the accumulated exposure to x-ray radiation that would build up in a single patient over the years of screening. Generally speaking, conventional CT radiation doses are usually at least an order of magnitude higher than the radiation doses associated with traditional two-dimensional x-ray images. By way of example, a traditional two-dimensional lateral or AP x-ray view of the head requires a dose of roughly 1-2 mGy, whereas a conventional head CT can incur a radiation dose of roughly 30-60 mGy. Thus using conventional CT radiation doses designed to maximize spatial and contrast resolution in the imaged plane, e.g., to 1 mm or less, a given patient would quickly reach a lifetime radiation limit beyond which an unreasonable risk of radiation-caused cancer would outweigh the benefits of any early anomaly detection provided by the screening process.

Yet another problem related to x-ray dosage in CT scans is the heat load to the CT x-ray tube. Conventional CT radiation dosage requirements cause the CT x-ray tube to heat up substantially during a single CT scan. The associated recovery time between patients limits overall system throughput to an extent that would be disadvantageous in an en masse screening environment.

Accordingly, it would be desirable to provide a method for processing and displaying three-dimensional medical imaging data in a manner amenable to a standardized screening process, analogous to today's x-ray mammography screening process, for lesions associated with a variety of different diseases affecting a variety of different body parts or organs.

It would be further desirable in the context of CT imaging, to provide such a medical screening method that reduces radiation risks for the patient.

It would be still further desirable to provide such a three-dimensional medical image processing and display method that could also be readily used for survey and/or diagnostic purposes in certain high-risk or symptomatic patients.

### SUMMARY

A method and associated systems for processing and displaying three-dimensional medical imaging data of a subject anatomical volume are provided in which a plurality of thick-slice images is computed and displayed each thick-slice image corresponding to a thick-slice or slab-like region of the anatomical volume substantially parallel to a standard x-ray view plane for that anatomical volume. Advantageously, the thick-slice images are of immediate and familiar significance to the radiologist having substantial training and experience in analyzing conventional x-ray images for the standard x-ray view plane. Unlike with conventional x-ray imaging however, information specific to each thick-slice or slab-like subvolume is provided. However, in contrast to the three-dimensional imaging modalities discussed above the radiologist is presented with a manageable number of images to view, which is particularly advantageous in a clinical screening environment.

According to a preferred embodiment, the thick-slice or slab-like subvolumes have a thickness generally related to a lesion size to be detected and/or examined. In one preferred embodiment, the slab-like regions have a thickness on the order of twice the average size of the lesion size to be detected and/or examined. Optionally, computer-aided diagnosis (CAD) results such as annotation markers may be placed on or near the thick-slice images as necessary, the CAD algorithms being performed on the thick-slice images, on a three-dimensional data volume from which the thick-slice images are computed, and/or on the individual “raw” image slices that were used to form the three-dimensional data volume.

Thick-slice processing and display according to the preferred embodiments is generally applicable for any anatomical volume having associated standard x-ray views that is also amenable to one or more three-dimensional imaging modalities. In one preferred embodiment, the anatomical volume is the head and neck region of the patient, and the standard x-ray view plane is the AP and/or lateral view. In another preferred embodiment, the anatomical volume is the chest region, and the standard x-ray view is the PA view and/or the lateral view. In another preferred embodiment, the anatomical volume is the breast, and the standard x-ray view is the CC view and/or the MLO view.

According to one preferred embodiment in which the particular three-dimensional imaging modality is CT imaging, thick-slice processing and display is used to facilitate reduced screening radiation dosage. Raw CT data is acquired at a substantially reduced radiation level as compared to conventional CT radiation doses and processed into a three-dimensional representation of the anatomical volume the thick-slice images being computed from the three-dimensional representation. Although each individual voxel in the three-dimensional representation would have a reduced signal-to-noise ratio and any individual plane therein would be noisier and less resolved in comparison to the conventional-dose case, the process of accumulating/compounding the CT data into the thick-slice images in accordance with the preferred embodiments has the advantageous effect of smoothing out the noise while preserving structures on the order of the lesions of interest in the anatomical volume.

### BRIEF DESCRIPTION OF THE DRAWINGS

FIG. 1 illustrates a conceptual example of a chest/abdomen volume, thick-slice subvolumes thereof and a thick-slice image display corresponding to a lateral x-ray view plane according to a preferred embodiment;

FIG. 2 illustrates a conceptual example of a chest/abdomen volume, thick-slice subvolumes thereof, and a thick-slice image display corresponding to a posterior-anterior (PA) x-ray view plane according to a preferred embodiment; and

FIG. 3 illustrates a conceptual example of a head volume, thick-slice subvolumes thereof, and a thick-slice image display corresponding to a lateral x-ray view plane according to a preferred embodiment.

### DETAILED DESCRIPTION

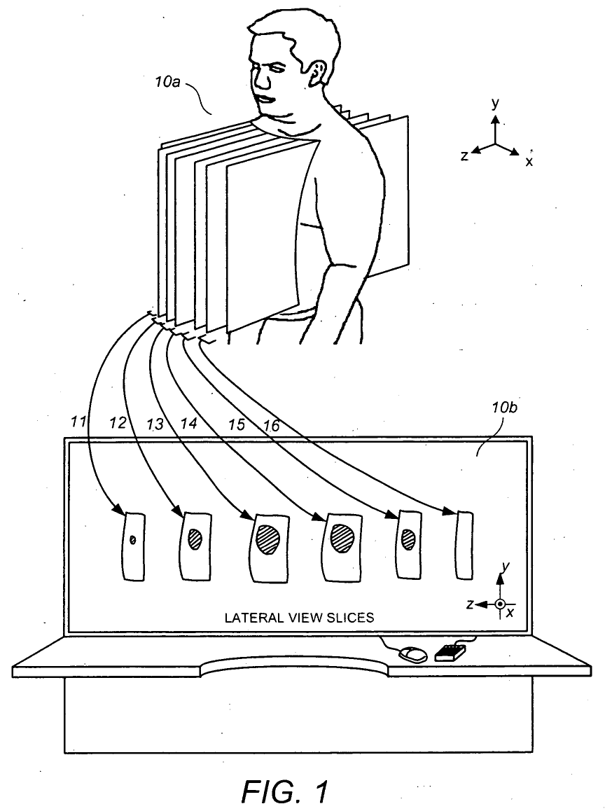

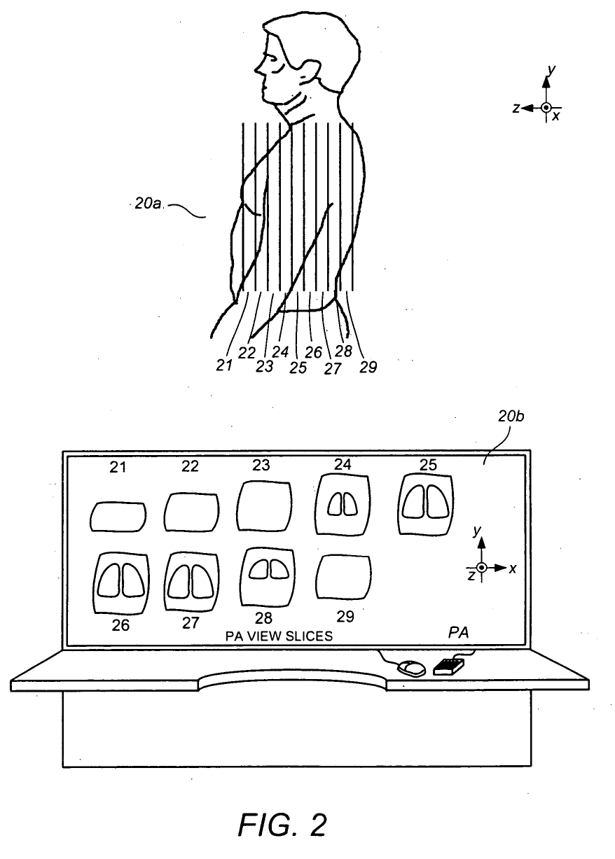

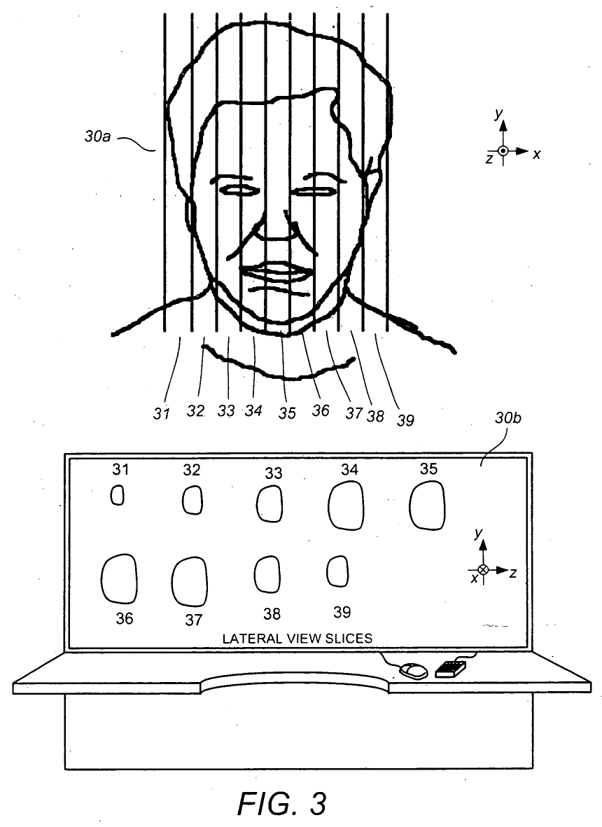

FIGS. 1-3 illustrate conceptual examples of anatomical subvolumes, slab-like regions, and displays of thick-slice images according to the preferred embodiments for different body portions and different standard x-ray views. FIG. 1 illustrates a conceptual example of a chest/abdomen volume 10a, thick-slice subvolumes 11-16 thereof, and a thick-slice image display 10b corresponding to a lateral x-ray view plane according to a preferred embodiment. FIG. 2 illustrates a conceptual example of a chest/abdomen volume 20a, thick-slice subvolumes 21-29 thereof, and a thick-slice image display 20b corresponding to a posterior-anterior (PA) x-ray view plane according to a preferred embodiment. FIG. 3 illustrates a conceptual example of a head volume 30a, thick-slice subvolumes 31-39 thereof, and a thick-slice image display 30b corresponding to a lateral x-ray view plane according to a preferred embodiment.

According to a preferred embodiment, the slab-like regions corresponding to the thick-slice images are approximately 1 cm thick for head, chest/abdominal, and breast regions. However, a variety of other thicknesses are within the scope of the preferred embodiments. By way of example and not by way of limitation, in other preferred embodiments the slab-like regions corresponding to the thick-slice images may be in the range of 0.5-2 cm thick for the head and neck regions, 1-3 cm thick for the chest and abdomen regions, and 0.5-2 cm thick for the breast. Accordingly, the number of thick-slice images for a given anatomical volume will usually be in the range of 4-20 thick-slice images. Advantageously, this is a substantial reduction from the conventional displays associated with the conventional native three-dimensional imaging modes discussed above. Furthermore, because they correspond to slab-like volumes substantially parallel to standard x-ray views the thick-slice images are of immediate and familiar significance to the radiologist. In another preferred embodiment, the slab-like regions have a thickness that is about twice the average size of the suspicious lesions sought, e.g., for detecting 0.6 cm lesions on average the slab-like regions would have a thickness of about 1.2 cm.

In one preferred embodiment, the thick-slice images correspond to slab-like regions that collectively occupy the entire anatomical volume. The plurality of images is displayed simultaneously, thereby providing a single view of the entire anatomical volume. Preferably, an interactive user display is provided that allows quick and easy navigation to, from, and among individual slices of interest. Optionally, the user display provides for quick selection and display of a planar image, the planar image corresponding to readings along a single plane cutting through the anatomical volume at a selected location and orientation. In one preferred embodiment, the single plane cuts through the anatomical volume along a plane perpendicular to the orientation of the slab-like regions corresponding to the thick-slice images. Notably, the thick-slice images do not replace the native imaging modality, but rather augment it. Where necessary, the radiologist may indeed access particular axial slices at their full resolution to arrive at a conclusive screening result.

Once a three-dimensional volumetric representation of the anatomical subvolume is obtained, such as by “stacking” the tomographic slices obtained from the raw CT scans, the thick-slice images can be computed from the three-dimensional volume using any of a variety of methods in a simplest method an average of voxel values along a voxel column corresponding to a particular output thick-slice image pixel is computed. Other techniques for integrating the voxel values into an output thick-slice image pixel include geometric averaging, reciprocal averaging exponential averaging, and other averaging methods, in each case including both weighted and unweighted averaging techniques. Other suitable integration methods may be based on statistical properties of the population of the voxels in the voxel column, such as maximum value, minimum value, mean, variance or other statistical algorithms.

According to another preferred embodiment in which the particular three-dimensional imaging mode is CT, the raw CT data is acquired at a substantially reduced radiation level as compared to the conventional CT radiation dose. Although each individual voxel in the three-dimensional representation will have a reduced signal-to-noise ratio and individual thin-slices will be noisier and have less resolution as compared to the conventional case, the process of accumulating/compounding individual slices into the thick-slice images in accordance with the preferred embodiments has the advantageous effect of smoothing out the noise while preserving structures on the order of the lesions of interest, e.g. on the order of 0.5 cm or greater. Stated another way, the thick-slice images do not “need” each voxel or thin-slice plane to have high 1-mm resolution and high SNR, because it is the larger structures over a slab-like region that are of more interest anyway. Advantageously, because of the substantially reduced radiation dose, a given patient will not accumulate dangerous x-ray radiation levels even if the screening procedure is repeated once every year or couple of years. Also, system throughput problems related to CT x-ray tube heat loads are substantially reduced or obviated altogether. In one preferred embodiment for a breast cancer screening environment, the breast CT dosage is lowered to an amount that roughly corresponds to the dosages used in today's conventional x-ray mammogram screening environments.

According to another preferred embodiment different gradations of x-ray radiation doses are progressively associated with a hierarchy of medical investigation levels. For a lowest level of suspicion, i.e. for general en masse screening of a population of a symptomatic patients, a lowest level of x-ray radiation is used in the CT scans. For an intermediate level of suspicion, e.g., for a particular at-risk patient or a patient having very mild symptoms, an intermediate level of x-ray radiation is used. For a high-level of suspicion, e.g., for a symptomatic patient a high or conventional amount of x-ray radiation is used. Corresponding to the hierarchy, of course is the resolution and SNR of the thick-slice images obtained, low-suspicion situations calling for coarser review and higher-suspicion cases calling for finer and more careful review.

In one preferred embodiment, a method for CT-based screening for breast cancer is provided in which low-risk patients such as women under 40 are imaged with the lowest doses of x-rav radiation. For women 40-50, the dosage (and resolution/SNR of the thick-slice images) is increased. For women over 50 and/or having a history of breast cancer in their families, an even higher CT x-ray radiation dose is used although the amount is still substantially less than for conventional diagnostic CT imaging.

According to another preferred embodiment. CAD algorithms are performed using the thick-slice images as starting points.. This can substantially simplify the computations required in CAD algorithms. In one example, the CAD algorithms comprise simple two-dimensional mass detection algorithms designed to detect, for example, lesions on the order of 0.5 cm. If no lesions are found in a given thick-slice image having a suspiciousness metric greater than a certain predetermined amount, e.g. 30%, the algorithm can proceed onto the next thick-slice image without further processing of the slab-like sub-volume. However if a lesion it is found having a suspiciousness metric greater than that predetermined amount, three-dimensional volumetric CAD algorithms are invoked on the slab-like subvolume of data. In another, simpler preferred embodiment, the CAD algorithm only performs two-dimensional mass detection algorithms and displays the results, if any, and the radiologist decides what action to take, if any, upon further review.

In an alternative preferred embodiment the slab-like regions are parallel to a native view of the three-dimensional imaging modality for example the axial view in the case of a CT image. In this preferred embodiment in which CT is used, the benefits of reduced-exposure CT scanning are still provided for the patient, and a reduced amount of processing is required because there are no reprojections required. Furthermore although the less-familiar axial view has to be analyzed, there are fewer images to analyze.

Whereas many alterations and modifications of the present invention will no doubt become apparent to a person skilled in the art after having read the foregoing description, it is to be understood that the particular embodiments shown and described by way of illustration are in no way intended to be considered limiting. By way of example one or more of the features described in the following publications each of which is incorporated by reference herein is readily implemented in conjunction with one or more of the preferred embodiments described supra: WO02/43801 A2 (Wang) published Jun. 6, 2002: US2003/007598A1 (Wang. et. al.) published Jan. 9, 2003: and US2003/0212327A1 (Wang, et. al.) published Nov. 13. 2003. By way of further example, while one or more preferred embodiments is described supra in the context of a screening process it is to be appreciated that the disclosed thick-slice methods can be readily used for diagnostic purposes on symptomatic patients as well. Therefore, reference to the details of the preferred embodiments are not intended to limit their scope, which is limited only by the scope of the claims set forth below.

What is claimed is:

1. A method for processing scans of an anatomical volume derived from a three-dimensional medical imaging modality, comprising:
computing from said scans a plurality of two-dimensional thick-slice images, each thick-slice image corresponding to a slab-like subvolume of the anatomical volume substantially parallel to a standard x-ray view plane for that anatomical volume: and
displaying said thick-slice images to a viewer.

2. The method of claim 1, wherein said viewer is a clinician screening for lesions within the anatomical volume.

3. The method of claim 2, wherein said slab-like subvolumes collectively occupy substantially all of the anatomical volume.

4. The method of claim 3, wherein all of said slab-like subvolumes are simultaneously displayed to the viewer.

5. The method of claim 4, further comprising displaying computer-aided detection (CAD) annotations to said viewer in conjunction with said thick-slice images.

6. The method of claim 2, wherein said slab-like subvolumes have an average thickness roughly equal to about twice an expected size of lesions to be detected according to the three-dimensional imaging modality.

7. The method of claim 6, said anatomical volume including a chest or abdomen volume, said average thickness being in the range of 1-3 cm, and said standard x-ray view plane being an anterior-posterior (PA) view or a lateral view.

8. The method of claim 6, said anatomical volume including a head or neck volume, said average thickness being in the range of 0.5-2 cm, and said standard x-ray view plane being a lateral view or a coronal view.

9. The method of claim 6, said anatomical volume including a breast volume, said average thickness being in the range of 0.5-2 cm and said standard x-ray view plane being a craniocaudal (CC) or mediolateral oblique (MLO) view.

10. The method of claim 6, wherein said three-dimensional medical imaging modality is CT, wherein the scans are obtained a substantially reduced radiation level as compared to a conventional CT imaging radiation level, and wherein said computing preserves structures approximately 0.5 cm or greater in size in said thick-slice images.

11. A system for screening for lesions in an anatomical volume using scans thereof derived from a three-dimensional medical imaging modality, comprising a display device simultaneously displaying a plurality of two-dimensional thick-slice images to a viewer, each thick-slice image corresponding to a slab-like subvolume of the anatomical volume substantially parallel to a standard x-ray view plane for that anatomical volume.

12. The system of claim 11, wherein said slab-like subvolumes collectively occupy substantially all of the anatomical volume and have an average thickness proportional to an expected size of lesions to be detected according to the three-dimensional imaging modality.

13. The system of claim 12, said anatomical volume including a chest or abdomen volume, said average thickness being in the range of 1-3 cm, and said standard x-ray view plane being an anterior-posterior (PA) view or a lateral view.

14. The system of claim 12, said anatomical volume including a head or neck volume, said average thickness being in the range of 0.5-2 cm, and said standard x-ray view plane being a lateral view or a coronal view.

15. The system of claim 6, said anatomical volume including a breast volume, said average thickness being in the range of 0.5-2 cm, and said standard x-ray view plane being a craniocaudal (CC) or mediolateral oblique (MLO) view.

16. An apparatus for processing scans of an anatomical volume derived from a three-dimensional medical imaging modality, comprising:
means for computing from said scans a plurality of two-dimensional thick-slice images, each thick-slice image corresponding to a slab-like subvolume of the anatomical volume substantially parallel to a standard x-ray view plane for that anatomical volume; and
means for displaying said thick-slice images to a viewer.

17. The apparatus of claim 16, wherein said slab-like subvolumes collectively occupy substantially all of the anatomical volume.

18. The apparatus of claim 17, further comprising means for displaying computer-aided detection (CAD) annotations associated with said thick-slice images to the viewer.

19. The apparatus of claim 18, wherein said slab-like subvolumes have an average thickness roughly equal to about twice an expected size of lesions to be detected according to the three-dimensional imaging modality.

20. The apparatus of claim 19, said anatomical volume including a chest or abdomen volume, said average thickness being in the range of 1-3 cm, and said standard x-ray view plane being an anterior-posterior (PA) view or a lateral view.
